(19) United States
(12) Patent Application Publication
(10) Pub. No.: US 2026/0152002 A1
(43) Pub. Date: Jun. 4, 2026

(54) INKJET HEAD CLEANING APPARATUS AND METHOD FOR CLEANING INKJET HEAD

(71) Applicant: SEMES CO., LTD., Chungcheongnam-do (KR)

(72) Inventor: Byung Joo LEE, Chungcheongnam-do (KR)

(21) Appl. No.: 19/347,729

(22) Filed: Oct. 2, 2025

(30) Foreign Application Priority Data
Dec. 3, 2024 (KR) 10-2024-0177074

(51) Int. Cl. B41J 2/165

(52) U.S. Cl. CPC B41J 2/16552; B41J 2002/16594

(57) ABSTRACT

An inkjet head cleaning apparatus includes: a first bath receiving a cleaning liquid from a supply tank, the first bath including a first bath bottom surface and a plurality of sidewalls connected to the first bath bottom surface, and having an open top; a second bath in contact with a first sidewall among the sidewalls of the first bath, the second bath including a second bath bottom surface; a water level detection sensor configured to detect a water level in the second bath; and a controller configured to control an amount of the cleaning liquid supplied to the first bath according to the detected water level in the second bath, wherein a machined groove is provided on the first sidewall of the first bath, and the cleaning liquid in the first bath overflows through the machined groove and is delivered to the second bath along the first sidewall.

### CROSS-REFERENCE TO RELATED APPLICATION

This application claims priority from Korean Patent Application No. 10-2024-0177074 filed on Dec. 3, 2024 in the Korean Intellectual Property Office, and all the benefits accruing therefrom under 35 U.S.C. 119, the contents of which in its entirety are herein incorporated by reference.

### BACKGROUND

### Technical Field

The present disclosure relates to an inkjet head cleaning apparatus and an inkjet head cleaning method for cleaning an inkjet head.

### Description of the Related Art

In general, in order to manufacture semiconductors, displays, and the like, a substrate processing system that performs predetermined processing, such as processing a substrate with a chemical liquid (which may also be referred to as a droplet or ink), may be used. For example, the substrate processing system may perform a printing process on a transparent substrate to manufacture a display device such as a liquid crystal display (LCD), and, for this purpose, may be provided with an inkjet head. The inkjet head may discharge ink onto the substrate to print the substrate.

However, when the inkjet head applies the chemical liquid, the chemical liquid may remain on the nozzle surface of the inkjet head, causing defects. Therefore, the nozzle surface of the inkjet head needs to be cleaned from time to time.

Accordingly, conventionally, maintenance work has been repeatedly performed by simply purging the chemical liquid until the impact point of the chemical liquid discharged from the nozzle portion of the inkjet head is maintained, or by discharging the residual chemical liquid through a preceding impact point operation prior to the main process, and when improvement is not achieved, by replacing the inkjet head. However, this causes delays in inkjet process equipment and results in high consumption costs for expensive inkjet heads.

Another method for cleaning an inkjet head is to clean the inkjet head by immersing the nozzle surface of the inkjet head in a cleaning liquid. This method has the problem of using an excessively large amount of cleaning liquid because the cleaning liquid must be continuously supplied during cleaning.

### SUMMARY

An objective of the present disclosure is to provide an apparatus and method for cleaning an inkjet head while reducing the amount of cleaning liquid used.

Another objective of the present disclosure is to provide an inkjet head cleaning apparatus and method, in which cleaning liquid can overflow from a first bath provided with a machined groove into another bath, and a water level detection sensor provided in the other bath can be used to control the supply of cleaning liquid to the first bath.

The objectives of the present disclosure are not limited to those mentioned above, and other objectives not explicitly stated will be clearly understood by those skilled in the art based on the following description.

According to an aspect of the present disclosure, an inkjet head cleaning apparatus includes: a first bath receiving a cleaning liquid from a supply tank, the first bath including a first bath bottom surface and a plurality of sidewalls connected to the first bath bottom surface, and having an open top; a second bath provided in contact with a first sidewall among the plurality of sidewalls of the first bath, the second bath including a second bath bottom surface; a water level detection sensor configured to detect a water level in the second bath; and a controller configured to control an amount of the cleaning liquid supplied to the first bath according to the detected water level in the second bath, wherein a machined groove is provided on the first sidewall of the first bath, and the cleaning liquid in the first bath overflows through the machined groove and is delivered to the second bath along the first sidewall.

According to an aspect of the present disclosure, an inkjet head cleaning apparatus includes: a supply tank; a first bath receiving a cleaning liquid from the supply tank, the first bath including a first bath bottom surface and a plurality of sidewalls connected to the first bath bottom surface, and having an open top; a supply line connecting the first bath and the supply tank; a first control valve provided in the supply line and configured to control the cleaning liquid supplied from the supply tank to the first bath; a second bath provided in contact with a first sidewall among the plurality of sidewalls of the first bath, the second bath including a second bath bottom surface; a water level detection sensor configured to detect a water level in the second bath; a recovery tank configured to drain the cleaning liquid from the second bath; a recovery line connecting the second bath and the recovery tank; a second control valve provided in the recovery line and configured to control the cleaning liquid drained from the second bath to the recovery tank; and a controller configured to control an amount of the cleaning liquid supplied to the first bath according to the detected water level in the second bath, wherein a machined groove is provided on the first sidewall of the first bath, the cleaning liquid in the first bath overflows through the machined groove and is delivered to the second bath along the first sidewall, and the water level detection sensor includes: a first water level detection sensor positioned outside one sidewall of the second bath; and a second water level detection sensor positioned outside the one sidewall of the second bath and spaced apart from the first water level detection sensor in a first direction.

According to an aspect of the present disclosure, an inkjet head cleaning method includes: supplying a cleaning liquid to a first bath; overflowing the cleaning liquid in the first bath into a second bath through a machined groove; detecting, by a water level detection sensor of the second bath, a water level of the cleaning liquid; stopping supply of the cleaning liquid to the first bath; and cleaning a nozzle surface by lowering a head.

It should be noted that the effects of the present disclosure are not limited to those described above, and other effects of the present disclosure will be apparent from the following description.

### BRIEF DESCRIPTION OF THE DRAWINGS

The above and other aspects and features of the present disclosure will become more apparent by describing exemplary embodiments thereof in detail with reference to the attached drawings, in which:

FIG. 1 is a schematic configuration diagram illustrating an inkjet head cleaning apparatus according to an embodiment of the present disclosure;

FIG. 2 is a cross-sectional view for explaining a machined groove provided in a first bath according to an embodiment of the present disclosure;

FIG. 3 is an enlarged perspective view of area A of FIG. 2 for explaining the machined groove provided in the first bath according to an embodiment of the present disclosure;

FIGS. 4, 5, 6, 7 and 8 are diagrams for explaining intermediate steps of an inkjet head cleaning method according to an embodiment of the present disclosure;

FIGS. 9, 10, 11, 12 and 13 are diagrams for explaining intermediate steps of an inkjet head cleaning method according to an embodiment of the present disclosure;

FIG. 14 is a bottom view of an inkjet head for explaining a nozzle surface provided with a chemical liquid discharge portion according to an embodiment of the present disclosure;

FIG. 15 is a block diagram of an inkjet head cleaning apparatus according to an embodiment of the present disclosure;

FIG. 16 is a block diagram of an inkjet head cleaning apparatus according to an embodiment of the present disclosure;

FIG. 17 is a flowchart for explaining an inkjet head cleaning method according to an embodiment of the present disclosure; and FIG. 18 is a flowchart for explaining an inkjet head cleaning method according to an embodiment of the present disclosure.

### DETAILED DESCRIPTION

Hereinafter, preferred embodiments of the present disclosure will be described in detail with reference to the accompanying drawings. Advantages and features of the present disclosure, and methods for achieving them, will become apparent by referring to the embodiments described below in detail together with the accompanying drawings. However, the present disclosure is not limited to the embodiments set forth below, but may be implemented in various other forms. These embodiments are provided only to ensure a complete description of the disclosure and to fully convey the scope of the disclosure to those skilled in the art. The present disclosure is defined only by the scope of the claims. Throughout the specification, like reference numerals refer to like elements.

Although “first,” “second,” and the like are used to describe various elements, components, and/or sections, it is to be understood that these elements, components, and/or sections are not limited by such terms. These terms are used only to distinguish one element, component, or section from another element, component, or section. Thus, a first element, first component, or first region to be mentioned below may also be a second element, second component, or second region within the technical scope of the present disclosure.

The terminology used herein is for the purpose of describing embodiments only and is not intended to limit the present disclosure. In this specification, the singular forms also include the plural forms unless the context clearly indicates otherwise. The terms “comprises” and/or “comprising,” as used in this specification, specify the presence of the stated components, steps, operations, and/or elements, but do not preclude the presence or addition of one or more other components, steps, operations, and/or elements.

In this specification, the term “chemical liquid” may be used interchangeably with “ink,” “substrate liquid,” or “treatment liquid” with the same meaning.

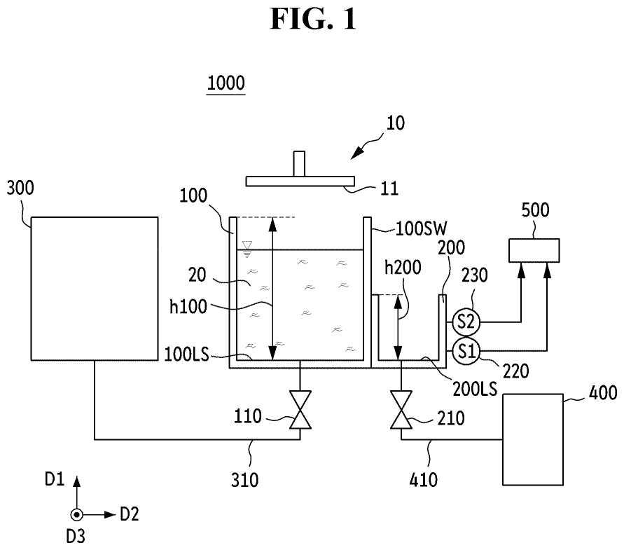

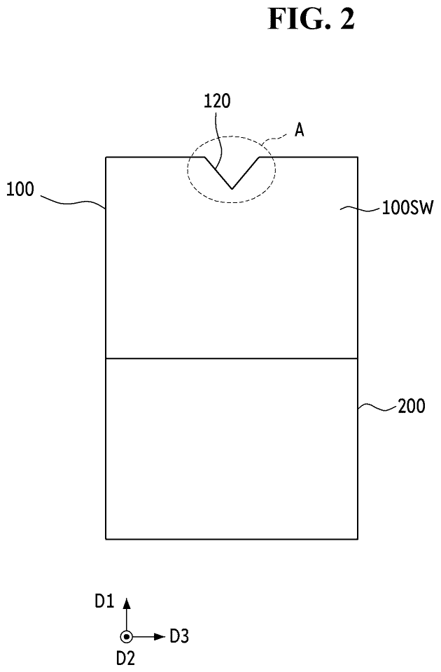

FIG. 1 is a schematic configuration diagram illustrating an inkjet head cleaning apparatus according to an embodiment of the present disclosure. FIG. 2 is a cross-sectional view for explaining a machined groove provided in a first bath according to an embodiment of the present disclosure.

Referring to FIGS. 1, 2 and 3, an inkjet head cleaning apparatus 1000 may include a first bath 100, a first control valve 110, a machined groove 120, a second bath 200, a second control valve 210, a first water level detection sensor 220, a second water level detection sensor 230, a supply tank 300, a supply line 310, a recovery tank 400, a recovery line 410, and a controller 500.

The inkjet head cleaning apparatus 1000 is an apparatus for cleaning a head 10 that may be used to perform a printing process on a substrate to manufacture a display device such as a liquid crystal display (LCD). Conventionally, the head 10 may be cleaned by simply purging chemical liquid remaining in a chemical liquid discharge portion 12 of the head 10, or by cleaning the chemical liquid discharge portion 12 of a nozzle surface 11 using a wire. In contrast, the inkjet head cleaning apparatus 1000 may clean the chemical liquid discharge portion 12 of the head 10 by immersing the nozzle surface 11 in cleaning liquid 20.

The first bath 100 may include a first bath bottom surface 100LS. The first bath 100 may include a plurality of sidewalls connected to the first bath bottom surface 100LS. Among the plurality of sidewalls, a first sidewall 100SW may be installed to be in contact with the second bath 200. The first bath 100 is open at its top.

Cleaning of the head 10 may be performed in the first bath 100. Specifically, the head 10 may include a nozzle. The nozzle surface 11 of the nozzle may include the chemical liquid discharge portion 12. The chemical liquid discharge portion 12 of the nozzle surface 11 may be immersed in the cleaning liquid 20 in the first bath 100 so that cleaning may be performed. The supply tank 300 may supply the cleaning liquid 20 to the first bath 100. The cleaning liquid 20 may be supplied to the first bath 100 through the first bath bottom surface 100LS. The supply line 310 may connect the first bath 100 and the supply tank 300. The first control valve 110 may be arranged in the supply line 310 to control supply of the cleaning liquid 20 from the supply tank 300 to the first bath 100.

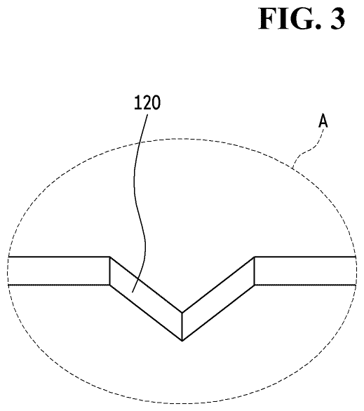

Referring to FIGS. 2 and 3, the first bath 100 may be provided with the machined groove 120 in the first sidewall 100SW. The machined groove 120 may be provided at an uppermost surface of the first sidewall 100SW of the first bath 100. The machined groove 120 may include a V-shaped notch. The machined groove 120 may allow cleaning liquid 20 to overflow from the first bath 100 to the second bath 200. The overflowing cleaning liquid 20 may be delivered to the second bath 200 along the first sidewall 100SW of the first bath 100. As illustrated in FIGS. 2 and 3, a single machined groove 120 may be provided, but this is merely exemplary. That is, the number of machined grooves 120 is not particularly limited.

Alternatively, a plurality of machined grooves 120 may be provided at the uppermost surface of the first sidewall 100SW of the first bath 100. The machined groove 120 may allow the cleaning liquid 20 in the first bath 100 to overflow in one direction. The shape of the machined groove 120 may include a V-shaped notch, but the shape of the machined groove 120 is not limited thereto. For example, although not illustrated, the shape of the machined groove 120 may include a U-shaped notch.

The second bath 200 may be arranged to be connected to the first bath 100.

Specifically, the second bath 200 may be installed in contact with the first sidewall 100SW of the first bath 100. The second bath 200 may receive the cleaning liquid 20 overflowing through the machined groove 120 of the first bath 100.

The capacity of the second bath 200 may be smaller than the capacity of the first bath 100. The first bath bottom surface 100LS and a second bath bottom surface 200LS may be located on the same plane. Being on the same plane may mean having the same height in a first direction D1. A height h100 of the first bath 100 may be greater than a height h200 of the second bath 200.

The cleaning liquid 20 in the second bath 200 may be drained to the recovery tank 400 through the second bath bottom surface 200LS. The recovery line 410 may connect the second bath 200 and the recovery tank 400. The second control valve 210 may be arranged in the recovery line 410 to control drainage of the cleaning liquid 20 from the second bath 200 to the recovery tank 400.

The second bath 200 may include at least one water level detection sensor for detecting the water level of the cleaning liquid 20. Referring to FIG. 1, the second bath 200 may include a first water level detection sensor 220 and a second water level detection sensor 230. The first water level detection sensor 220 may be provided on the outside of one sidewall of the second bath 200. The second water level detection sensor 230 may be spaced apart from the first water level detection sensor 220 in the first direction D1, on the inside or outside of the sidewall of the second bath 200. When the first and second water level detection sensors 220 and 230 are positioned on the outside of the sidewall of the second bath 200, the first and second water level detection sensors 220 and 230 may detect the water level of the cleaning liquid 20 in a non-contact manner. The first and second water level detection sensors 220 and 230 may input the detected water level to the controller 500.

The first water level detection sensor 220 may input detection information to the controller 500 when the water level of the cleaning liquid 20 in the second bath 200 rises above a first water level h1. The second water level detection sensor 230 may input detection information to the controller 500 when the water level of the cleaning liquid 20 in the second bath 200 rises above a second water level h2. The controller 500, which has received the detection information, may control opening and closing of the first control valve 110. When the water level of the cleaning liquid 20 in the second bath 200 exceeds the first water level h1, the controller 500 may control the first control valve 110 to close. When the first control valve 110 is closed, supply of the cleaning liquid 20 from the supply tank 300 to the first bath 100 may be stopped. When the water level of the cleaning liquid 20 in the second bath 200 exceeds the second water level h2, the second water level detection sensor 230 may input detection information to the controller 500. The controller 500, which has received the detection information, may control opening and closing of the first control valve 110. When the first control valve 110 is closed, supply of the cleaning liquid 20 from the supply tank 300 to the first bath 100 may be stopped. That is, the detection information input from the first and second water level detection sensors 220 and 230 to the controller 500 may be used to control opening and closing of the first control valve 110.

The first and second control valves 110 and 210 are illustrated in FIG. 1 as both being in an open state.

The recovery tank 400 may recover the cleaning liquid 20 drained from the second bath 200. Although not illustrated, the cleaning liquid 20 in the recovery tank 400 may be reused. Although not illustrated, the cleaning liquid 20 in the recovery tank 400 may be sent to a waste liquid tank. A destination of the cleaning liquid 20 in the recovery tank 400 may be determined in consideration of contamination of the cleaning liquid 20 and the like.

The controller 500 may be electrically connected to the first and second water level detection sensors 220 and 230. The controller 500 may receive detection information detected by the first and second water level detection sensors 220 and 230 according to the water level in the second bath 200. The controller 500 may control opening and closing of the first control valve 110 based on the received detection information. That is, the controller 500 may control the amount of the cleaning liquid 20 supplied to the first bath 100 according to the detected water level in the second bath 200.

Although not illustrated, the controller 500 may be electrically connected to the first and second control valves 110 and 210. When the water level in the second bath 200 exceeds the first water level h1, the controller 500 may control the first control valve 110 to close. When the water level in the second bath 200 exceeds the second water level h2, the controller 500 may control the first control valve 110 to close. After cleaning the nozzle surface 11 is completed, the controller 500 may control the cleaning liquid 20 in the second bath 200 to be drained to the recovery tank 400. For the drainage, the controller 500 may control the second control valve 210 to be opened.

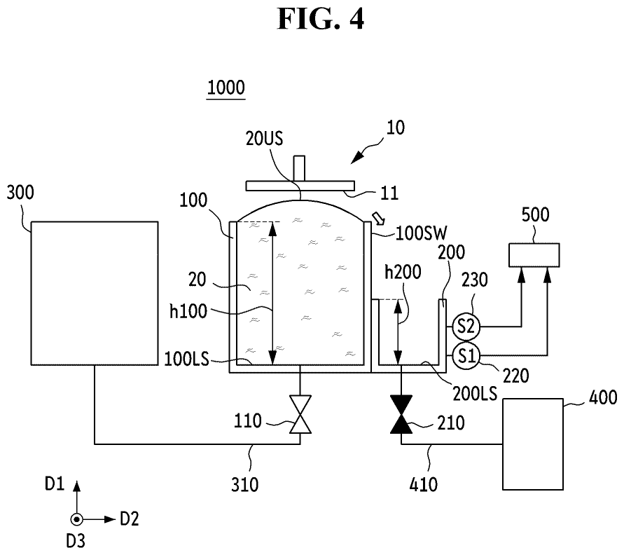

FIGS. 4, 5, 6, 7 and 8 are diagrams for explaining intermediate steps of an inkjet head cleaning method according to an embodiment of the present disclosure.

Specifically, FIGS. 4, 5, 6, 7 and 8 are diagrams for explaining a process in which the controller 500 controls supply of the cleaning liquid 20 to the first bath 100 based on detection information from the first water level detection sensor 220.

Referring to FIG. 4, the cleaning liquid 20 may be supplied from the supply tank 300 to the first bath 100. The cleaning liquid 20 may be supplied to the first bath 100 through the first bath bottom surface 100LS. The first bath 100 may be filled with the cleaning liquid 20, and due to surface tension, the uppermost surface 20US of the cleaning liquid 20 may protrude above the first bath 100. Referring to FIG. 4, the first control valve 110 is open, and the second control valve 210 is closed.

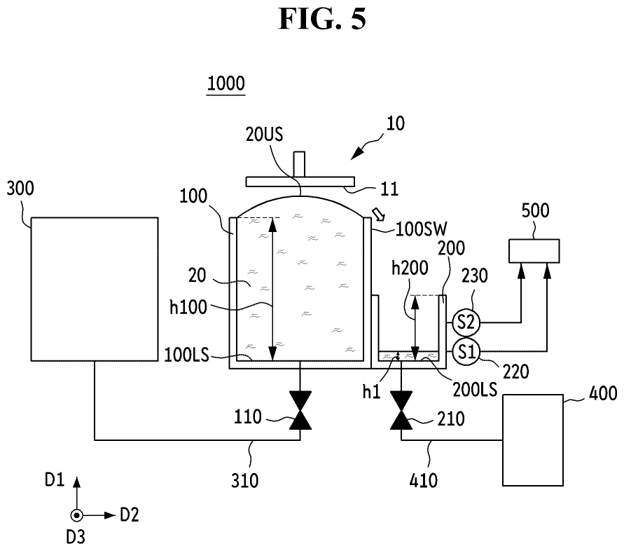

Referring to FIG. 5, the cleaning liquid 20 overflowing from the first bath 100 may be delivered to the second bath 200 through the machined groove 120 (in FIG. 2) provided at the uppermost surface of the first sidewall 100SW of the first bath 100. The cleaning liquid 20 overflowing from the first bath 100 may be delivered to the second bath 200 along the first sidewall 100SW of the first bath 100.

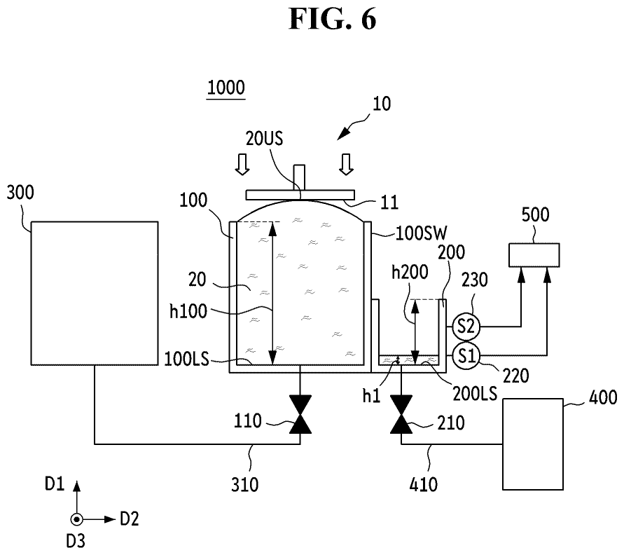

The first water level detection sensor 220 may detect whether the water level of the cleaning liquid 20 in the second bath 200 has reached the first water level h1. When the water level of the cleaning liquid 20 overflowing from the first bath 100 to the second bath 200 reaches the first water level h1, the first water level detection sensor 220 may input detection information to the controller 500. The controller 500 may control the first control valve 110 to close based on the detection information from the first water level detection sensor 220. When the first control valve 110 is closed, supply of the cleaning liquid 20 from the supply tank 300 to the first bath 100 may be stopped. Referring to FIGS. 5 and 6, the first and second control valves 110 and 210 are closed.

Referring to FIG. 6, when supply of the cleaning liquid 20 to the first bath 100 is stopped, cleaning of the nozzle surface 11 of the head 10 may be performed using the cleaning liquid 20 filled in the first bath 100. The head 10 may move downward in a direction opposite to the first direction D1. The nozzle surface 11 of the head 10 may be cleaned by the cleaning liquid 20 filled in the first bath 100. Specifically, in a state where the uppermost surface 20US of the cleaning liquid 20 in the first bath 100 protrudes above the first bath 100 due to surface tension, the nozzle surface 11 may be immersed in the cleaning liquid 20 to be cleaned. Cleaning of the nozzle surface 11 may include cleaning of the chemical liquid discharge portion 12 provided on the nozzle surface 11. The chemical liquid adhering around the chemical liquid discharge portion 12 may be removed by the cleaning liquid 20. The cleaning liquid 20 may be used to clean a blocked chemical liquid discharge portion 12.

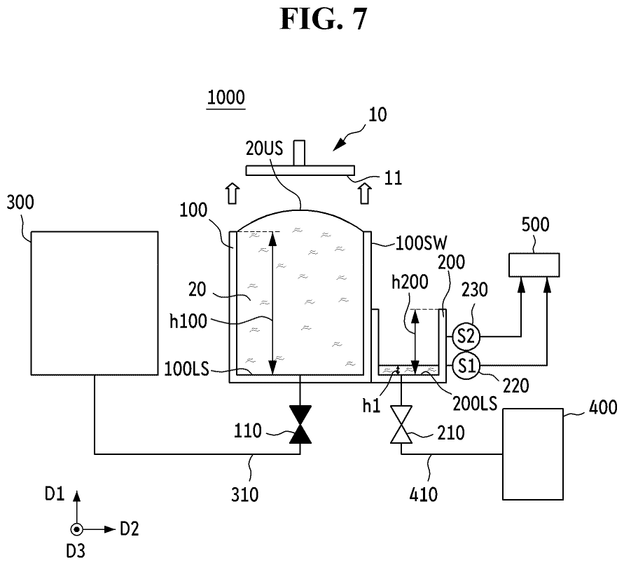

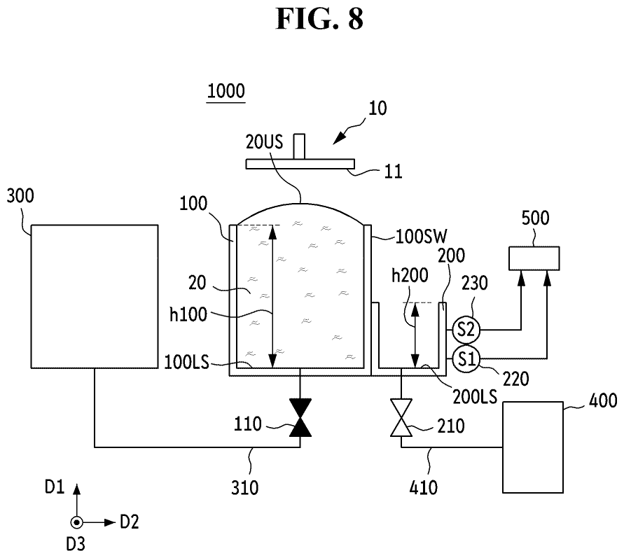

Referring to FIGS. 7 and 8, after cleaning of the nozzle surface 11 is completed, the head 10 may move upward in the first direction D1. After cleaning the nozzle surface 11 is completed, the cleaning liquid 20 in the second bath 200 may be drained to the recovery tank 400. Specifically, the cleaning liquid 20 may be drained to the recovery tank 400 through the second bath bottom surface 200LS. The controller 500 may command the second control valve 210 to open so that the cleaning liquid 20 in the second bath 200 is drained to the recovery tank 400. The second control valve 210, provided in the recovery line 410, may be used to control, through opening and closing operations, the amount of the cleaning liquid 20 drained from the second bath 200 to the recovery tank 400. The cleaning liquid 20 in the second bath 200 may be completely drained to the recovery tank 400. After drainage to the recovery tank 400 is completed, the controller 500 may command the second control valve 210 to close.

After draining the cleaning liquid 20 from the second bath 200, the controller 500 may resume supply of the cleaning liquid 20 to the first bath 100. The controller 500 may control supply of the cleaning liquid 20 from the supply tank 300 to the first bath 100 to resume. The controller 500 may control the first control valve 110 to open in order to resume supply of the cleaning liquid 20 to the first bath 100. When the first control valve 110 is opened, the cleaning liquid 20 may be supplied until the first water level detection sensor 220 detects that the water level in the second bath 200 has reached the first water level h1. Referring to FIGS. 7 and 8, the first control valve 110 is open, and the second control valve 210 is closed.

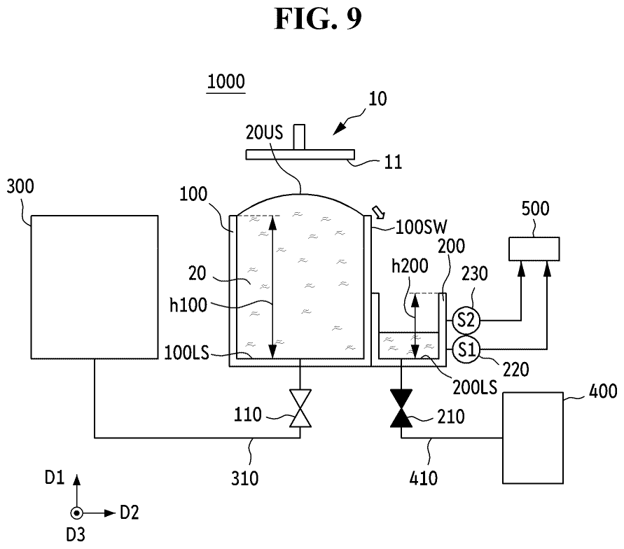

FIGS. 9, 10, 11, 12 and 13 are diagrams for explaining intermediate steps of an inkjet head cleaning method according to an embodiment of the present disclosure.

FIGS. 9, 10, 11, 12 and 13 are diagrams for explaining a process in which the controller 500 controls supply of the cleaning liquid 20 to the first bath 100 based on detection information from the second water level detection sensor 230.

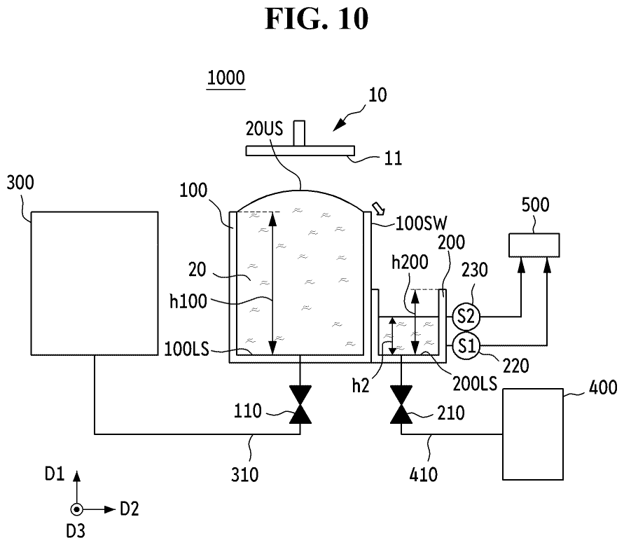

Referring to FIGS. 9 and 10, the cleaning liquid 20 may be supplied from the supply tank 300 to the first bath 100 through the first bath bottom surface 100LS. The first bath 100 may be filled with the cleaning liquid 20, and due to surface tension, the uppermost surface 20US of the cleaning liquid 20 may protrude above the first bath 100.

The first water level detection sensor 220 may malfunction or fail. In this case, even when the water level in the second bath 200 reaches the first water level h1, the first water level detection sensor 220 cannot detect the water level of the cleaning liquid 20. The first water level detection sensor 220 cannot input detection information to the controller 500. When the first water level detection sensor 220 malfunctions or fails, supply of the cleaning liquid 20 to the first bath 100 may continue even if the water level in the second bath 200 reaches the first water level h1. Accordingly, the water level in the second bath 200 may become higher than the first water level h1. When the water level of the cleaning liquid 20 overflowing from the first bath 100 to the second bath 200 reaches the second water level h2, the second water level detection sensor 230 may input detection information to the controller 500. The controller 500 may control the first control valve 110 to close based on the detection information from the second water level detection sensor 230. When the first control valve 110 is closed, supply of the cleaning liquid 20 from the supply tank 300 to the first bath 100 may be stopped. Referring to FIG. 9, the first control valve 110 is open, and the second control valve 210 is closed. Referring to FIG. 10, the first and second control valves 110 and 210 are closed.

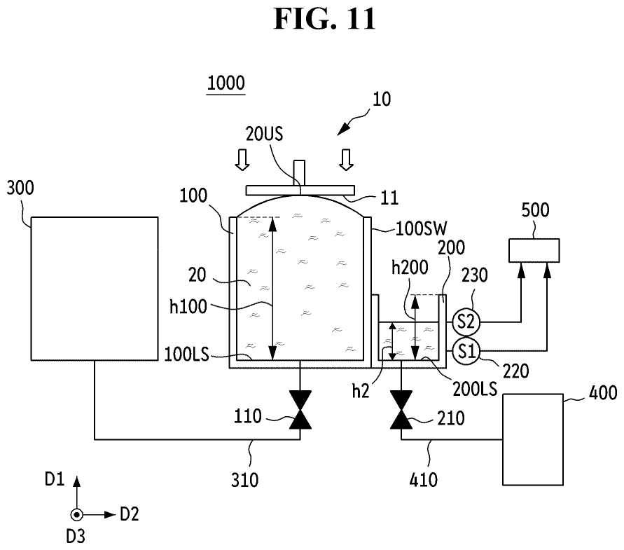

Referring to FIG. 11, when supply of the cleaning liquid 20 to the first bath 100 is stopped, cleaning of the nozzle surface 11 of the head 10 may be performed using the cleaning liquid 20 filled in the first bath 100. The head 10 may move downward in the direction opposite to the first direction D1. The nozzle surface 11 of the head 10 may be cleaned by the cleaning liquid 20 filled in the first bath 100. Specifically, in a state where the uppermost surface 20US of the cleaning liquid in the first bath 100 protrudes above the first bath 100 due to surface tension, the nozzle surface 11 may be immersed in the cleaning liquid 20 to be cleaned. Cleaning of the nozzle surface 11 may include cleaning of the chemical liquid discharge portion 12 provided on the nozzle surface 11. The chemical liquid adhering around the chemical liquid discharge portion 12 may be removed by the cleaning liquid 20. The cleaning liquid 20 may be used to clean a blocked chemical liquid discharge portion 12. Referring to FIG. 11, the first and second control valves 110 and 210 are closed.

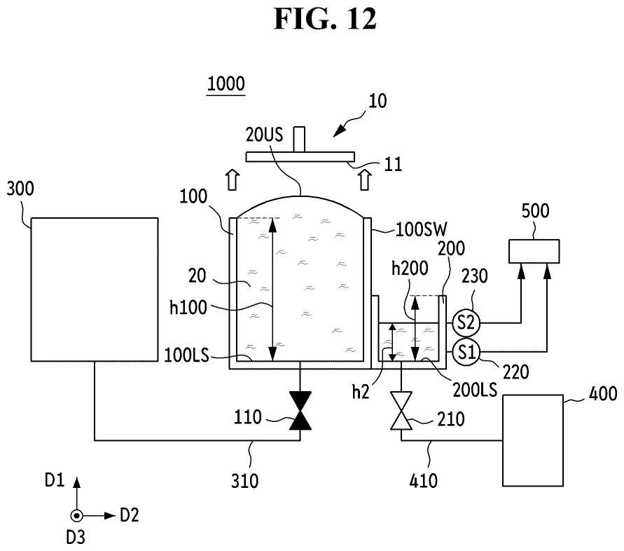

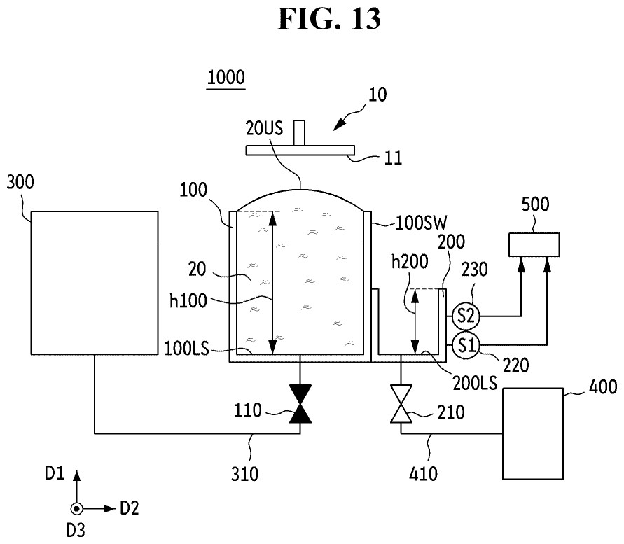

Referring to FIGS. 12 and 13, after cleaning of the nozzle surface 11 is completed, the head 10 may move upward in the first direction D1. The cleaning liquid 20 in the second bath 200 may then be drained to the recovery tank 400. Specifically, the cleaning liquid 20 may be drained to the recovery tank 400 through the second bath bottom surface 200LS. The controller 500 may command the second control valve 210 to open so that the cleaning liquid 20 in the second bath 200 is drained to the recovery tank 400. The second control valve 210, provided in the recovery line 410, may be used to control, through opening and closing operations, the amount of the cleaning liquid 20 drained from the second bath 200 to the recovery tank 400. The cleaning liquid 20 in the second bath 200 may be completely drained to the recovery tank 400. After drainage to the recovery tank 400 is completed, the controller 500 may command the second control valve 210 to close.

After draining the cleaning liquid 20 from the second bath 200, the controller 500 may resume supply of the cleaning liquid 20 to the first bath 100. The controller 500 may control supply of the cleaning liquid 20 from the supply tank 300 to the first bath 100 to be resumed. The controller 500 may control the first control valve 110 to open in order to resume supply of the cleaning liquid 20 to the first bath 100. When the first control valve 110 is opened, the cleaning liquid 20 may be supplied until the second water level detection sensor 230 detects that the water level in the second bath 200 has reached the second water level h2. Referring to FIGS. 12 and 13, the first control valve 110 is open, and the second control valve 210 is closed.

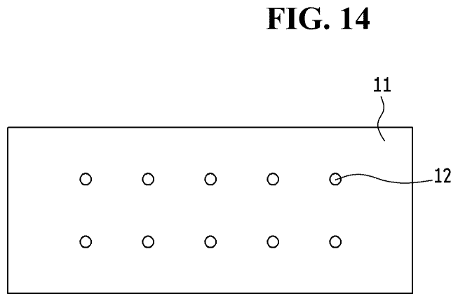

FIG. 14 is a bottom view of an inkjet head for explaining a nozzle surface provided with chemical liquid discharge portions according to an embodiment of the present disclosure.

Referring to FIG. 14, the head 10 may include a nozzle. The nozzle may include a nozzle surface 11. A plurality of chemical liquid discharge portions 12 may be provided on the nozzle surface 11. As illustrated in FIG. 14, ten chemical liquid discharge portions 12 may be provided, but the number of chemical liquid discharge portions 12 is not limited thereto. A chemical liquid used for various processes and substrate treatment may be discharged from the chemical liquid discharge portions 12. The chemical liquid may include ink. The chemical liquid may include a substrate liquid. The chemical liquid may include a treatment liquid. When the chemical liquid is repeatedly discharged from the chemical liquid discharge portions 12, the chemical liquid may be scattered on the nozzle surface 11. When the chemical liquid is repeatedly discharged from the chemical liquid discharge portions 12, the chemical liquid remaining on the chemical liquid discharge portions 12 may be present. Here, the inkjet head cleaning apparatus 1000 is an apparatus for cleaning the nozzle surface 11 and the chemical liquid discharge portions 12 provided on the nozzle surface 11 using a cleaning liquid.

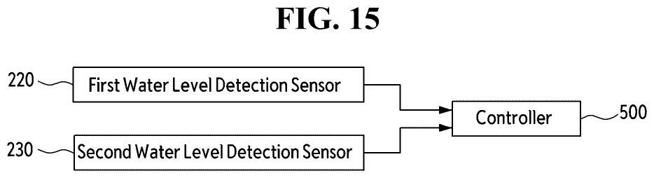

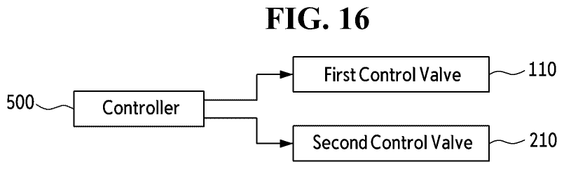

FIG. 15 is a block diagram of an inkjet head cleaning apparatus according to an embodiment of the present disclosure. FIG. 16 is a block diagram of an inkjet head cleaning apparatus according to an embodiment of the present disclosure.

The controller 500 may be electrically connected to the first and second water level detection sensors 220 and 230.

The controller 500 may receive a detection result sensed by the first water level detection sensor 220. When the water level of the cleaning liquid 20 in the second bath 200 reaches the first water level h1, the first water level detection sensor 220 may input the detection result to the controller 500.

The controller 500 may receive a detection result sensed by the second water level detection sensor 230. When the water level of the cleaning liquid 20 in the second bath 200 reaches the second water level h2, the second water level detection sensor 230 may input the detection result to the controller 500.

The controller 500 may be electrically connected to the first and second control valves 110 and 210.

The controller 500 may receive detection information from the first and second water level detection sensors 220 and 230 and may control opening and closing of the first control valve 110.

When the water level of the cleaning liquid 20 in the second bath 200 reaches the first water level h1, the first water level detection sensor 220 may input the detection result to the controller 500. The controller 500 may receive detection information from the first water level detection sensor 220 and may control the first control valve 110 to close.

When the water level of the cleaning liquid 20 in the second bath 200 reaches the second water level h2, the second water level detection sensor 230 may input the detection result to the controller 500. The controller 500 may receive detection information from the second water level detection sensor 230 and may control the first control valve 110 to close.

After cleaning of the head 10 is completed, the controller 500 may control the second control valve 210 to open. When the second control valve 210 is opened, the cleaning liquid 20 in the second bath 200 may be drained to the recovery tank 400 along the recovery line 410.

After cleaning of the head 10 is completed, the controller 500 may control the first control valve 110 to open. When the first control valve 110 is opened, the first bath 100 may receive the cleaning liquid 20 from the supply tank 300 along the supply line 310.

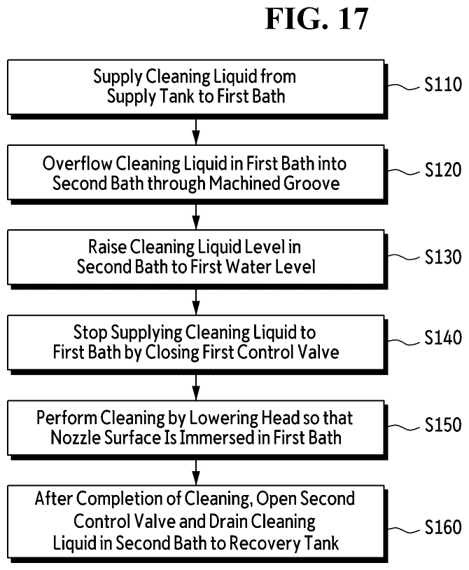

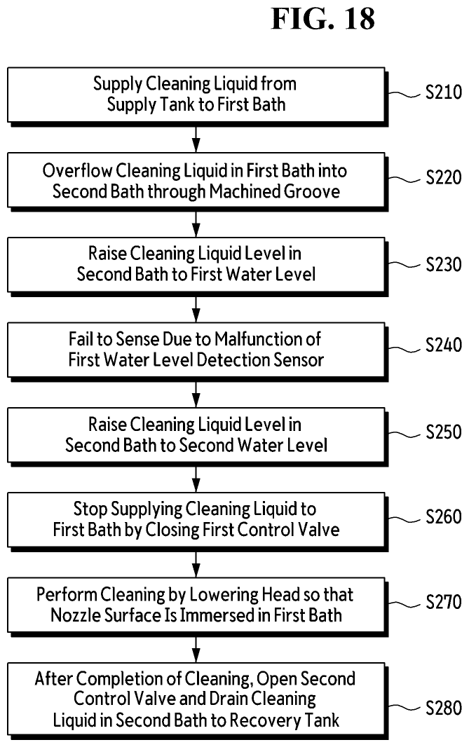

FIG. 17 is a flowchart for explaining an inkjet head cleaning method according to an embodiment of the present disclosure.

The cleaning liquid 20 may be supplied from the supply tank 300 to the first bath 100 (S110).

The cleaning liquid 20 in the first bath 100 may overflow to the second bath 200 through the machined groove 120 (S120). The cleaning liquid 20 overflowing from the first bath 100 may be delivered to the second bath 200 along the first sidewall 100SW of the first bath 100.

The water level of the cleaning liquid 20 in the second bath 200 may rise to the first water level h1 (S130). When the water level of the cleaning liquid 20 in the second bath 200 rises to the first water level h1, the first water level detection sensor 220 may input detection information to the controller 500.

The controller 500 may close the first control valve 110 to stop supply of the cleaning liquid 20 to the first bath 100 (S140). The controller 500 may control the first control valve 110 to close based on the detection information input from the first water level detection sensor 220.

The head 10 may move downward so that the nozzle surface 11 is immersed in the first bath 100 and cleaning is performed (S150). The head 10 may include a nozzle. In the present disclosure, the expression that the head 10 moves downward may be used interchangeably with the expression that the nozzle moves downward. During cleaning, due to surface tension, the uppermost surface 20US of the cleaning liquid 20 in the first bath 100 may protrude in the first direction D1 beyond the first bath 100. After the cleaning is completed, the head 10 may move upward in the first direction D1.

After the cleaning is completed, the second control valve 210 may be opened to drain the cleaning liquid 20 in the second bath 200 to the recovery tank 400 (S160). The controller 500 may control opening and closing of the second control valve 210.

FIG. 18 is a flowchart for explaining an inkjet head cleaning method according to an embodiment of the present disclosure.

The cleaning liquid 20 may be supplied from the supply tank 300 to the first bath 100 (S210).

The cleaning liquid 20 in the first bath 100 may overflow to the second bath 200 through the machined groove 120 (S220). The cleaning liquid 20 overflowing from the first bath 100 may be delivered to the second bath 200 along the first sidewall 100SW of the first bath 100.

The water level of the cleaning liquid 20 in the second bath 200 may rise to the first water level h1 (S230).

When the first water level detection sensor 220 malfunctions, even if the cleaning liquid 20 reaches the first water level h1, sensing cannot be performed (S240). When the first water level detection sensor 220 malfunctions, the first water level detection sensor 220 cannot input detection information to the controller 500.

The water level of the cleaning liquid 20 in the second bath 200 may rise to the second water level h2 (S250). When the water level of the cleaning liquid 20 in the second bath 200 rises to the second water level h2, the second water level detection sensor 230 may input detection information to the controller 500.

The controller 500 may close the first control valve 110 to stop supply of the cleaning liquid 20 to the first bath 100 (S260). The controller 500 may control the first control valve 110 to close based on the detection information input from the second water level detection sensor 230.

The head 10 may move downward so that the nozzle surface 11 is immersed in the first bath 100 and cleaning is performed (S270). The head 10 may include a nozzle. In the present disclosure, the expression that the head 10 moves downward may be used interchangeably with the expression that the nozzle moves downward. During cleaning, due to surface tension, the uppermost surface 20US of the cleaning liquid 20 in the first bath 100 may protrude in the first direction D1 beyond the first bath 100. After the cleaning is completed, the head 10 may move upward in the first direction D1.

After the cleaning is completed, the second control valve 210 may be opened to drain the cleaning liquid 20 in the second bath 200 to the recovery tank 400 (S280). The controller 500 may control opening and closing of the second control valve 210.

Although embodiments according to the technical idea of the present disclosure have been described with reference to the accompanying drawings, the present disclosure is not limited to the embodiments, but may be manufactured in various different forms, and those of ordinary skill in the art to which the present disclosure pertains can understand that the present disclosure may be embodied in other specific forms without changing the technical idea or essential features of the present disclosure. Therefore, the embodiments described above are to be understood as illustrative in all respects and not restrictive.

1. An inkjet head cleaning apparatus comprising:
a first bath receiving a cleaning liquid from a supply tank, the first bath including a first bath bottom surface and a plurality of sidewalls connected to the first bath bottom surface, and having an open top;
a second bath in contact with a first sidewall among the plurality of sidewalls of the first bath, the second bath including a second bath bottom surface;
a water level detection sensor configured to detect a water level in the second bath; and
a controller configured to control an amount of the cleaning liquid supplied to the first bath according to the detected water level in the second bath,
wherein
a machined groove is provided on the first sidewall of the first bath, and
the cleaning liquid in the first bath overflows through the machined groove and is delivered to the second bath along the first sidewall.

2. The inkjet head cleaning apparatus of claim 1, wherein the machined groove includes a V-shaped notch provided on an uppermost surface of the first sidewall.

3. The inkjet head cleaning apparatus of claim 1, wherein the cleaning liquid is supplied to the first bath through the first bath bottom surface.

4. The inkjet head cleaning apparatus of claim 3, further comprising:
a supply line connecting the first bath and the supply tank.

5. The inkjet head cleaning apparatus of claim 4, further comprising:
a first control valve provided in the supply line and configured to control the cleaning liquid supplied from the supply tank to the first bath.

6. The inkjet head cleaning apparatus of claim 1, further comprising:
a recovery tank configured so that the cleaning liquid in the second bath is drained through the second bath bottom surface.

7. The inkjet head cleaning apparatus of claim 6, further comprising:
a recovery line connecting the second bath and the recovery tank.

8. The inkjet head cleaning apparatus of claim 7, further comprising:
a second control valve provided in the recovery line and configured to control the cleaning liquid drained from the second bath to the recovery tank.

9. The inkjet head cleaning apparatus of claim 1, wherein
the first and second bath bottom surfaces are located on the same plane, and
a height of the first bath is greater than a height of the second bath.

10. The inkjet head cleaning apparatus of claim 1, wherein the water level detection sensor includes: a first water level detection sensor positioned outside one sidewall of the second bath; and a second water level detection sensor positioned outside the one sidewall of the second bath and spaced apart from the first water level detection sensor in a first direction.

11. The inkjet head cleaning apparatus of claim 10, wherein
the first water level detection sensor detects whether the water level in the second bath has reached a first water level, and
the second water level detection sensor detects whether the water level in the second bath has reached a second water level higher than the first water level.

12. The inkjet head cleaning apparatus of claim 1, wherein
the water level detection sensor detects that the water level in the second bath has reached a first water level,
then, the controller stops the supply of the cleaning liquid to the first bath according to the detection result from the water level detection sensor,
then, nozzle surface cleaning is performed by the cleaning liquid filled in the first bath, and
then, the cleaning liquid in the second bath is drained.

13. The inkjet head cleaning apparatus of claim 12, wherein after draining the cleaning liquid in the second bath, the controller resumes supply of the cleaning liquid to the first bath, and the cleaning liquid is supplied to the first bath until the water level detection sensor detects that the water level in the second bath has reached the first water level.

14. The inkjet head cleaning apparatus of claim 1, wherein, in a state in which the first bath is filled with the cleaning liquid and an uppermost surface of the cleaning liquid protrudes beyond the first bath due to surface tension, a nozzle surface is immersed in the cleaning liquid and cleaned.

15. An inkjet head cleaning apparatus comprising:
a supply tank;
a first bath receiving a cleaning liquid from the supply tank, the first bath including a first bath bottom surface and a plurality of sidewalls connected to the first bath bottom surface, and having an open top;
a supply line connecting the first bath and the supply tank;
a first control valve provided in the supply line and configured to control the cleaning liquid supplied from the supply tank to the first bath;
a second bath provided in contact with a first sidewall among the plurality of sidewalls of the first bath, the second bath including a second bath bottom surface;
a water level detection sensor configured to detect a water level in the second bath;
a recovery tank configured to drain the cleaning liquid from the second bath;
a recovery line connecting the second bath and the recovery tank;
a second control valve provided in the recovery line and configured to control the cleaning liquid drained from the second bath to the recovery tank; and
a controller configured to control an amount of the cleaning liquid supplied to the first bath according to the detected water level in the second bath,
wherein
a machined groove is provided on the first sidewall of the first bath,
the cleaning liquid in the first bath overflows through the machined groove and is delivered to the second bath along the first sidewall, and the water level detection sensor includes: a first water level detection sensor positioned outside one sidewall of the second bath; and a second water level detection sensor positioned outside the one sidewall of the second bath and spaced apart from the first water level detection sensor in a first direction.

16. The inkjet head cleaning apparatus of claim 15, wherein the controller is configured to control opening and closing of the first control valve based on detection information input from the water level detection sensor.

17-20. (canceled)
